(19) United States
(12) Patent Application Publication
(10) Pub. No.: US 2019/0030500 A1
(43) Pub. Date: Jan. 31, 2019

(54) Apparatus And Process For Flocculation Of Solids Fractions Of A Solid-Liquid Mixture

(71) Applicant: Clariant International Ltd., Muttenz (CH)

(72) Inventors: Jochen KNAUER, Bad Homburg v. d. Höhe (DE); Gerard A. SOUTHWOOD, München (DE); Adnan SEFER, Waldkraiburg (DE)

(73) Assignee: Clariant International Ltd., Muttenz (CH)

(21) Appl. No.: 16/071,446

(22) PCT Filed: Jan. 13, 2017
(86) PCT No.: PCT/EP2017/050647

§ 371 Date: Jul. 19, 2018

(30) Foreign Application Priority Data
Jan. 27, 2016 (DE) 10 2016 101 417.6

(51) Int. Cl. B01F 7/00; B01F 5/06; C02F 11/14; C02F 1/52

(52) U.S. Cl. CPC B01F 7/00908; B01F 5/0606; B01F 13/103; C02F 1/5281; C02F 11/14

(57) ABSTRACT

The present invention relates in particular to an apparatus for flocculation of solids fractions of a solid-liquid mixture, in particular sludge or gray water, having a mixing sector (6, M) configured for conducting the solid-liquid mixture having a first mixing unit (5) having a static mixer (14) adapted for admixing a first flocculation agent and having a second mixing unit (7) fluidly connected in series with the first mixing unit (5) having a dynamic mixer (16, 18) adapted for admixing a second flocculation agent into the mixing sector (6, M).

The invention relates to an apparatus and a process for flocculating solids fractions of a solid-liquid mixture such as, for example, sludge or wastewater.

Such apparatuses and processes find application in the treatment or else remediation of sludges originating, for example, from industry, of sludges from mining, and of sludges in water bodies and wastewater treatment plants.

WO 2014/064073 discloses, for example, a process for flocculating sludge wherein the sludge, for the purpose of coagulation of the solids fractions, is sludge-contacted with a surface-treated, natural calcium carbonate, a natural bentonite, and an anionic polymer.

WO 2009/065509 A1 discloses an apparatus and a process for treating sludge wherein the sludge is first disintegrated and subsequently the disintegrated sludge is admixed with a polymer-comprising flocculant.

Starting from this basis, it is an object of the invention to specify a new apparatus and a new process for flocculating solid-liquid mixtures, such as sludge or graywater, for example, which permit coagulation, more particularly reliable coagulation, of the solids fractions and separation thereof from the liquid fraction.

This object is achieved in particular through the features of the embodiments in accordance with the independent claims. Further embodiments for achieving this object are apparent in particular from the dependent claims and also from the description hereinafter.

The herein-described features and feature combinations in accordance with the underlying invention are not confined by the feature combination(s) selected in the claims and by the selected dependency references. Any feature of a claim category, such as of an apparatus, for example, may also be claimed, for example, in another claim category, such as in a process, for example. Furthermore, any feature in the claims, even independently of the respective dependency reference in the claim, may be claimed, for example, in any desired combination with one or more other features of the claims or of the description hereinafter. Furthermore, any feature which is disclosed or described in the description hereinafter and/or in the appended drawings may be claimed as it is, independently of or detached from the context in which it stands, alone or in any combination with one or more other features disclosed or described in the claims, in the description and/or in the drawings.

In one embodiment of the invention in accordance with claim 1, relating to an apparatus for flocculating solids fractions of a solid-liquid mixture, more particularly sludge or graywater, the apparatus comprises a mixing sector designed for conducting the solid-liquid mixture.

The apparatus proposed may for example be an apparatus for admixing flocculating agents into a solid-liquid mixture, such as sludge or wastewater. The apparatus may comprise, for example, a pump unit, or more generally a feed unit or charging unit, for supplying the solid-liquid mixture to the mixing sector, and/or there may be an interface by which the apparatus proposed herein may be connected to such a pump unit etc. Additionally or alternatively, the apparatus may comprise a separator, such as a filter unit, for example, with which solids, more particularly coagulated solids of the solid-liquid mixture, may be separated, i.e., at least partly parted from the liquid fraction.

The mixing sector in turn comprises a first mixing unit and a second mixing unit, the second unit being more particularly different from the first unit. The mixing sector may comprise, for example, a pipeline or a section of pipeline at or in which the first and second mixing units are designed, and being suitable for allowing the passage through of a particular solid-liquid mixture to be treated.

At the ends of the mixing sector there may be interfaces, in the form for example of couplings or connecting flanges, which are designed to allow the mixing sector to be connected, for example, to an upstream feed pump unit and/or to a downstream solids separator.

The first mixing unit, in accordance with the embodiment of claim 1, comprises a static mixer which is adapted and designed for admixing a first flocculating agent, or flocculant, to the mixing sector.

The mixing sector further comprises a second mixing unit, which is connected fluidically in series with the first mixing unit, being more particularly connected or sited fluidically downstream of the first mixing unit. The second mixing unit comprises a dynamic mixer which is adapted for admixing a second flocculating agent, or second flocculant, to the mixing sector.

By using a static mixer and a dynamic mixer connected in series with it, more particularly a dynamic mixer disposed downstream or connected fluidically downstream, it is possible in the mixing sector to achieve comparatively good mixing and commixing of the flocculating agents with the solid-liquid mixture and also comparatively good and stable coagulation of the solids fractions of the solid-liquid mixture, this making it possible in turn to have comparatively high efficiency in the separation of the solids fractions of the solid-liquid mixture.

In embodiments, provision may be made for the static mixer to comprise one or more impact means, more particularly impact plates, designed in the volume of the mixing sector, as for example in the volume of the conveying line, and/or for the dynamic mixer to comprise one or more mixing rotors protruding into the volume of the conveying line and coupled to a motor drive unit.

In embodiments, provision may be made, for example, for the apparatus to have a mixing sector wherein the dynamic mixer with mixing rotor is disposed fluidically—that is, in the flow traversal direction through the mixing sector that is envisaged for the solid-liquid mixture in regular operation—downstream of the static mixer, which in particular may comprise one or more impact plates. In such embodiments it is therefore possible first to admix the first flocculating agent to the solid-liquid mixture by means of the static mixer and, considered fluidically, thereafter to admix the second flocculating agent by means of the dynamic mixer to the solid-liquid mixture.

In embodiments, provision may be made for at least one of the at least one impact means, more particularly impact plate, to have an impact surface which is disposed transversely, more particularly perpendicularly, to the flow traversal direction of the solid-liquid mixture that comes about in regular operation of the apparatus. Particularly with perpendicular positioning of the impact surface of the impact unit(s), more particularly of the impact plate(s), it is possible to achieve comparatively good admixing of the flocculating agent.

In embodiments, provision may be made for at least one of the at least one impact unit, more particularly impact plate, to be disposed centrally in relation to a cross-sectional area of the mixing sector that exists at the assembly location of the impact unit, more particularly impact plate, as for example the cross-sectional area of a corresponding mixing pipe, in which the impact unit, more particularly impact plate, is located. In the case of a circular cross section of the volume defined by the mixing sector, and in the case, for example, of a likewise circular impact surface, more particularly impact plate, an annular gap, for example, may be generated or provided as the flow cross section at the location of the impact surface, more particularly impact plate, this gap having, for example, a width which is constant or substantially constant in the peripheral direction. In particular, annular gaps in connection with passive mixers and/or static mixers have proven useful for efficient admixing of flocculating agents, such as calcium carbonate (CaCO₃), for example.

By means of the impact unit, more particularly impact plate, having an impact surface disposed, for example, centrally in relation to the diameter in the mixing sector, and having a correspondingly designed gap, more particularly annular gap, it is possible to achieve, for example, an increase in the flow rate in the region of the impact unit and the development of turbulence by the solid-liquid mixture flow in the region of the impact unit, and thereby to achieve the possibility of obtaining improved commixing and flocculation.

The size of the impact surface, and hence the reduction in the cross section of the mixing sector at the location of the impact surface, may be selected, for example, in dependence on the respective solid-liquid mixture and/or in dependence on the respective flocculating agent and/or flocculating agents and/or their compositions and/or the geometry of the mixing sector and/or the respective volume flow through the mixing sector.

In embodiments, provision may be made for the free cross-sectional area of the mixing sector at the location of the impact surface, as for example at the assembly location of the impact plate, i.e., the cross-sectional area provided by the mixing sector as such, as for example a corresponding mixing pipe, to be 2 to 3 times, as for example about 2.25 times, the impact area measured transversely to the flow traversal direction, i.e., the effective impact area, of the impact plate, for example. For a mixing sector diameter in the region of about 25 cm, for example, the diameter of the impact surface may be about 10 cm. In this way it is possible, in particular, to achieve a reduction in the free cross-sectional area of the mixing sector by about 30% to 50%. Cross section proportions of this kind have proven particularly advantageous for the admixing of the first flocculating agents described herein. The free cross-sectional area of the mixing sector may be, or is to be, understood in particular as the flow cross section of the mixing sector that exists perpendicular to the middle flow line, with assumed laminar flow through the mixing sector and with no impact plate present, in other words the free internal diameter of the mixing sector as such.

In embodiments, provision may be made for the first mixing unit to comprise a first supply unit (or: first injection unit), designed for the supply—for example, passive supply or pump-assisted active supply—of the first flocculating agent to the mixing sector, this first supply unit having at least one first supply opening (or: first injection opening), sited fluidically upstream of the mixer, more particularly of the static mixer, of the first mixing unit, for the first flocculating agent to the mixing sector.

In further embodiments, the second mixing unit may comprise a second supply unit (or: second injection unit), designed for the supply—for example, passive supply or pump-assisted active supply—of the second flocculating agent to the mixing sector, this second supply unit having at least one second supply opening (or: second injection opening) sited fluidically upstream of the mixer, more particularly of the dynamic mixer, of the second mixing unit, for the second flocculating agent to the mixing sector. In accordance with such embodiments, in particular, the mixing sector may be designed such that both the first and the second flocculating agents are added or supplied upstream of their respectively associated mixers.

In embodiments, provision may be made for the first supply unit to comprise a first supply lance, protruding into the mixing volume defined by the mixing sector, it being possible for at least one first supply opening to be designed on this lance. In further embodiments, provision may be made for the second supply unit to comprise a second supply lance, protruding into the mixing volume defined by the mixing sector, it being possible for at least one second supply opening to be designed on this lance. By using supply lances it is possible for the first and/or second flocculating agents to be supplied in a targeted way into the flow volume, as for example in the region of the middle flow line or centrally to the flow cross section, and/or in the region in which maximum flow rates occur, so that, in particular, it is possible to achieve comparatively good admixing of the respective flocculating agent. The supply lances may in each case, for example, comprise one or more outlet or injection openings or nozzles, adapted so as to introduce the respective flocculating agent in appropriate concentration and/or distribution into the solid-liquid mixture.

In embodiments, provision may be made for at least one first and/or at least one second supply opening to be designed at a distal end of the respective supply lance, this end being sited within the mixing volume, and being positioned, for example, approximately centrally to the free cross section of the mixing sector. Supply openings may additionally or alternatively be designed along the longitudinal extent of the respective supply lance.

In embodiments, the supply unit or injection unit may comprise an annular nozzle via which the flocculating agent can be supplied to the mixing volume. The annular nozzle may be disposed, for example, within the mixing volume, more particularly centrally in the mixing volume, so that the opening defined by the annular gap of the annular nozzle is disposed transversely, more particularly at a specified angle, as for example an angle of 45°, to the flow direction of the solid-liquid mixture.

In embodiments, provision may be made for the first and/or second supply openings of the first and/or second mixing units, respectively, to be designed, for example, transversely, more particularly obliquely or perpendicularly, to the flow cross section of the mixing sector at the location of the respective supply opening. More particularly the respective supply opening may be designed and aligned in such a way that a normal vector of the opening area of the supply opening runs transversely, more particularly obliquely or perpendicularly, to the flow vector of the solid-liquid mixture or parallel to the flow cross-sectional area of the mixing unit. In embodiments, provision may be made for the supply opening to be designed and aligned in such a way that the normal vector of the opening area is aligned at a specified angle to the flow vector. In particular, the supply opening may be disposed in such a way that it is aligned at a specified angle to the flow direction of the solid-liquid mixture, as for example at an angle of 45°, upstream, i.e., opposite, to the flow direction of the solid-liquid mixture. A corresponding alignment of the supply opening makes it possible in particular to achieve a comparatively uniform mixing outcome and/or, given appropriate orientation obliquely to the flow direction, it is possible to achieve an additional fluidizing effect.

In embodiments, provision may be made for a distance measured in the flow direction, i.e., parallel to the flow traversal direction of the solid-liquid mixture through the mixing sector, more particularly along the flow center line which results on assumption of laminar flow, or along the center axis of the mixing sector volume, i.e., a center-to-center distance, between the first supply opening, i.e., the supply opening for the first flocculating agent, and the mixer of the first mixing unit, more particularly the static mixer, to be 0.6 times to 1.2 times, more particularly 0.74 times, the free diameter of the mixing sector at the location or in the region of the first mixing unit, or at the location of an assigned mixer, or at the location or in the region of the first supply opening.

Correspondingly, in further embodiments, provision may be made for a distance measured in the flow direction, i.e., parallel to the flow traversal direction of the solid-liquid mixture through the mixing sector, more particularly along the flow center line which results on assumption of laminar flow, or along the center axis of the mixing sector volume, this distance being the distance between the second supply opening and the mixer, more particularly dynamic mixer, of the second mixing unit, to be 0.6 times to 1.2 times, more particularly 0.74 times, the free diameter of the mixing sector at the location or in the region of the second mixing unit or of the second supply opening. As and when required, even greater distances can be used in order to achieve optimum or satisfactory flocculating outcomes. For example, distances may be in the region of 50 m and/or in the region of 200 times the free diameter in order to enable, as and when required, sufficient development and maturation.

With the distances stated above, it is possible to achieve comparatively advantageous degrees of commixing, in association with advantageous and stable coagulation of the solids fractions, particularly with regard to sludges, such as industrial sludges, for example, from copper mines or other mines for metal recovery or in coal mining.

In embodiments, provision may be made for a distance measured in the flow direction between the first mixing unit, more particularly between the assigned first or static mixer, and the second supply opening of the second mixing unit to be between 0.8 and 1.2 times the free diameter of the mixing sector at the location or in the region of the first mixing unit or mixer and/or at the location or in the region of the second supply opening. Here as well it is possible in principle for larger distances to be used, as for example up to the region of one or more meters, as for example up to 50 meters, in which case the respectively selected distances are adapted so that sufficient maturation and development of the flocs can be achieved. In particular, by establishing or using a respectively suitable ratio, which may be dependent on the sludge or on the particular solid-liquid mixture, it is possible to ensure that the first flocculating agent is sufficiently commixed with the solid-liquid mixture before said mixture reaches the second mixing unit, at which the second flocculating agent is supplied or admixed.

A distance between first and second mixing units, as for example between the first mixing unit, more particularly the first or static mixer, and the second mixing unit, more particularly the second supply opening or the second or dynamic mixer, may in embodiments also amount to values different from those indicated above. For example, the distance, in particular independently of the respective diameter of the mixing sector, may be in the region of up to one or more meters, and may for example be up to 50 m. The distance may be selected, for example, where appropriate in dependence on the particular solid-liquid mixture for treatment and/or on the particular flocculating agent or agents used, such that in the mixing sector there is a possibility of sufficient maturation and development of the flocs that are to be formed.

In embodiments of the invention which in particular may be claimed independently, provision may be made for a device for admixing flocculating agents into a solid-liquid mixture, according to one of the embodiments described so far, for example, to comprise a mixing sector, or the mixing sector designed for conducting the solid-liquid mixture, that comprises one or the first and one or the second mixing unit. In such embodiments in particular, provision may be made for the second mixing unit to be sited fluidically downstream of the first mixing unit, and for the first mixing unit to be adapted, and especially modified, for the purpose of admixing the or a first flocculating agent to the mixing sector, and for the second mixing unit to be adapted, and especially modified for the purpose, of admixing the or a second flocculating agent to the mixing sector. In such embodiments, in particular, the first flocculating agent may comprise a carbonate and/or calcium salt, more particularly calcium carbonate (CaCO₃), or may consist of the stated compounds, and the second flocculating agent may comprise at least one acrylamide-free polymer or may consist of such a polymer. The surface of the calcium carbonate (CaCO₃) may optionally have been pretreated with phosphoric acid (H₃PO₄).

In relation to the above-stated embodiments, it has emerged in particular that with the specific combination of the flocculating agents, as for example a combination of CaCO₃, preferably surface-treated CaCO₃, and at least one acrylamide-free polymer, and/or with the specific nature of the admixing of the flocculating agents, especially for industrial sludges, in spite of the low flocculating effect of the acrylamide-free polymers in comparison to acrylamide-based polymers, it is possible to achieve a comparatively high degree of coagulation, especially stable coagulation, of solids fractions in the solid-liquid mixture, on the one hand, and, on account of the acrylamide-free polymers, to achieve a comparatively environmentally low-impact process, on the other hand. Regarding examples of suitable flocculating agents, reference is made, by way of example, to WO 2014/064073 A1.

In embodiments, particularly in accordance with the type described before, provision may be made for a distance, measured in the flow direction, between the first supply opening and the mixer of the first mixing unit, and/or between the second supply opening and the mixer of the second mixing unit, to be 0.6 to 1.2 times, more particularly 0.74 times, the free diameter (d₆) of the mixing sector at the location or in the region of the first or second mixing unit, respectively. Furthermore, in other embodiments, provision may be made for a distance, measured in the flow direction, between the mixer of the first mixing unit and the second supply opening to be between 0.8 and 1.2 times the free diameter of the mixing sector at the location or in the region of the first mixing unit and/or at the location or in the region of the second supply opening, respectively. As already mentioned, the stated distances may also be larger, and may be selected in dependence on the properties of the respective solid-liquid mixture and/or on the respective flocculating agents and/or in dependence on the geometry of the mixing sector and of the mixing units, etc., with reference being made to the observations earlier on above, which are valid correspondingly.

In relation to the aforesaid distances, reference is made to the observations earlier on above for advantages and advantageous effects. Additionally it should be mentioned that the stated distances are advantageous not only for the use of a static or dynamic mixer for the first or second mixing unit, respectively, but that these distances have also proven advantageous for the abovementioned specific, two-stage and successive admixing of the first flocculating agent based on CaCO₃ and of the second flocculating agent based on at least one acrylamide-free polymer.

In embodiments, provision may be made for the polymer to be an anionic or cationic, preferably water-based polymer and/or for the polymer to comprise a polyelectrolyte.

In embodiments of the invention, as claimed in claim 8, a process is envisaged for flocculating solids fractions of a solid-liquid mixture, where the solid-liquid mixture in question may be, for example, sludge, e.g., industrial sludge, or graywater.

To implement the process, it is possible more particularly to use an apparatus as claimed in one of the embodiments described herein, this being intended to denote that all features described and stated in connection with embodiments of the apparatus can also be employed in corresponding application in the claimed process, and vice versa. Reference is made explicitly to the above observations relating to the apparatus, which are to be valid here correspondingly.

In embodiments, provision may be made for the solid-liquid mixture in the process to be conducted through a mixing sector, as for example a mixing pipe or a mixing line, with the solid-liquid mixture being admixed in the mixing sector with a first flocculating agent by means of a static mixer of a first mixing unit, and with a second flocculating agent by means of a dynamic mixer of a second mixing unit, in the course of the conduction or during the passage through the mixing sector, with the second mixing unit being fluidically connected in series with the first mixing unit, more particularly being sited fluidically downstream of the first mixing unit or connected fluidically downstream.

For example, viewed in terms of flow technology, the second mixing unit may be sited downstream, i.e., the second mixing unit may be disposed in a direction parallel to the flow of the solid-liquid mixture, downstream of the first mixing unit. In other words, in the case of the process proposed, from a fluidic or flow-technical viewpoint, the solid-liquid mixture flowing through or conducted through the mixing sector is admixed first with the first flocculating agent, by using a static mixer, and then with the second flocculating agent, by using a dynamic mixer. Such a combination of type and flow-technical disposition of the mixers, in particular, has proven advantageous in terms of the achievable coagulation outcome. For further advantages and advantageous effects, reference is made to the above observations concerning the apparatus, which are to apply correspondingly.

In embodiments it is possible to envisage a process, more particularly a process claimable separately and/or else in combination with features of the above process, wherein, for the purpose of flocculating solids fractions of a solid-liquid mixture, the solid-liquid mixture is conducted through a or the mixing sector, and in the mixing sector the solid-liquid mixture is admixed first with a or the first flocculating agent and then, fluidically downstream, with a or the second flocculating agent, where the first flocculating agent comprises or consists of a carbonate and/or calcium salt, more particularly calcium carbonate (CaCO₃), and where the second flocculating agent comprises or consists of at least one acrylamide-free polymer. The surface of the calcium carbonate (CaCO₃) may optionally have been pretreated with phosphoric acid (H₃PO₄), meaning that the calcium carbonate may have been subjected to a surface treatment with phosphoric acid.

In relation to the specific combination of flocculating agents described in regard of this process, and to the specific sequence of the admixing, reference may be made to the above observations concerning the apparatus. In particular, however, it should be mentioned that the specific combination and sequence of the addition of flocculating agents produce comparatively good coagulation results, and the process proposed can be regarded as particularly gentle on the environment, in view of the use of the acrylamide-free polymer or polymers.

In embodiments, especially of the process, provision may be made for the first flocculating agent to be supplied to the solid-liquid mixture via a first supply unit, sited upstream of a first mixer of the first mixing unit, as for example of the static mixer.

In embodiments, furthermore, provision may be made for the second flocculating agent to be supplied to the solid-liquid mixture via a second supply unit, sited fluidically upstream of a second mixer of the second mixing unit, as for example of the dynamic mixer.

In particular, by adding the flocculating agents upstream of the mixers, it is possible to achieve an advantageous, especially comparatively uniform admixing of the flocculating agents, in conjunction with comparatively good coagulation outcomes, as a result of the mixers sited downstream, more particularly connected fluidically downstream, especially in accordance with the embodiment described herein using a static and a dynamic mixer, in the context of sludges.

In embodiments, the first flocculating agent may be supplied to the solid-liquid mixture via a first supply lance which protrudes into the mixing volume defined by the mixing sector. In further embodiments, the second flocculating agent may be supplied to the solid-liquid mixture by a second supply lance, which protrudes into the mixing volume defined by the mixing sector. By carrying out supply via supply lances it is possible, for example, to establish the position of delivery of the flocculating agents into the solid-liquid mixture, and accordingly, taking account for example of the types of mixer used and of the structure and geometry of the mixing sector, to obtain the respectively optimum supply and admixing of the flocculating agents to the solid-liquid mixture. For the supply of the flocculating agent or agents it is possible for example to use a nozzle, in the form of an annular nozzle, for example.

In embodiments, provision may be made for the first and/or second flocculating agents to be supplied at a position sited approximately centrally in the free cross section of the mixing sector. For example, the flocculating agent may be supplied via a lance, where the supply opening may be sited in the region of the center axis of the mixing sector. A central addition, especially in conjunction with one or more impact units or impact surfaces, more particularly impact plates and/or a dynamic mixer, as for example a mixer with radial mixing vanes, whose axis of rotation may be disposed, for example, perpendicularly to the flow in the mixing sector, makes it possible in particular for the admixing of the flocculating agent or agents to be homogeneous.

In embodiments, provision may be made for the first and/or second flocculating agents to be supplied to the solid-liquid mixture with a directional component running transversely, more particularly perpendicularly, to the flow direction of the solid-liquid mixture that prevails at the respective location of supply in the mixing sector. For example, the respective flocculating agent may be supplied, more particularly sprayed in or injected, through a lance, nozzle opening, nozzle or supply opening that is aligned transversely, as for example at an angle of 45° direction upstream, to the flow in the mixing sector.

In embodiments, provision may be made for at least one of the flocculating agents to be provided in the form of a solid, more particularly powder, and to be dissolved in a carrier liquid, water for example, before being supplied to the solid-liquid mixture, and/or before being supplied to the mixing sector. Through the use of powder as starting material it is possible in particular to vary the amount of the respectively supplied flocculation-active flocculating agent and/or to modify accordingly the concentration of the flocculation powder in solution in the carrier liquid. The flocculating agent may in particular be added in powder form or in a form in solution in carrier liquid.

In embodiments, provision may be made for a flow-technical distance in the flow direction or the flow traversal direction of the solid-liquid mixture, between the location of the addition of the first and/or second flocculating agents and the mixer of the respective first or second mixing unit, to be 0.6 to 1.2 times, more particularly 0.74 times, the free diameter (d₆) of the mixing sector, measured at the location or in the region of the first or second mixing unit, respectively. Such distances produce comparatively good commixing of flocculating agents and solid-liquid mixture, especially in the case of sludges.

In further embodiments, provision may be made for a flow-technical distance between the location or the region of the addition of the second flocculating agent and first mixing unit, especially of the first mixing unit sited upstream in terms of flow, as for example between the location or region of the addition of the second flocculating agent and the first mixer—for example upstream first mixer—of the first mixing unit, to be between 0.8 and 1.2 times the free diameter of the mixing sector at the location or in the region of the first mixing unit and/or at the location or in the region of the addition of the flocculating agent. Distances of this kind between the location or the region of the addition of a flocculating agent and a mixer situated flow-technically upstream in particular, i.e. connected upstream, make it possible, especially in the conditioning of sludges, to achieve comparatively good and homogeneous commixing with both flocculating agents.

The invention, including in relation to further features and advantages, is elucidated in more detail below on the basis of an exemplary working example, with reference to the appended drawings. In the drawings:

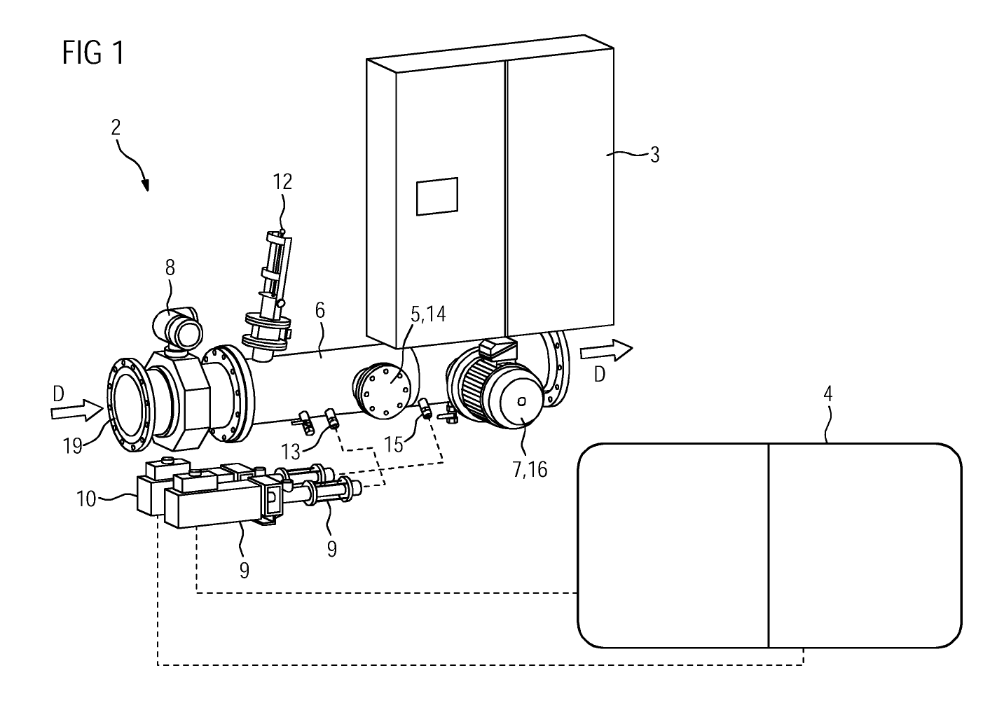

FIG. 1 shows an exemplary apparatus of the invention;

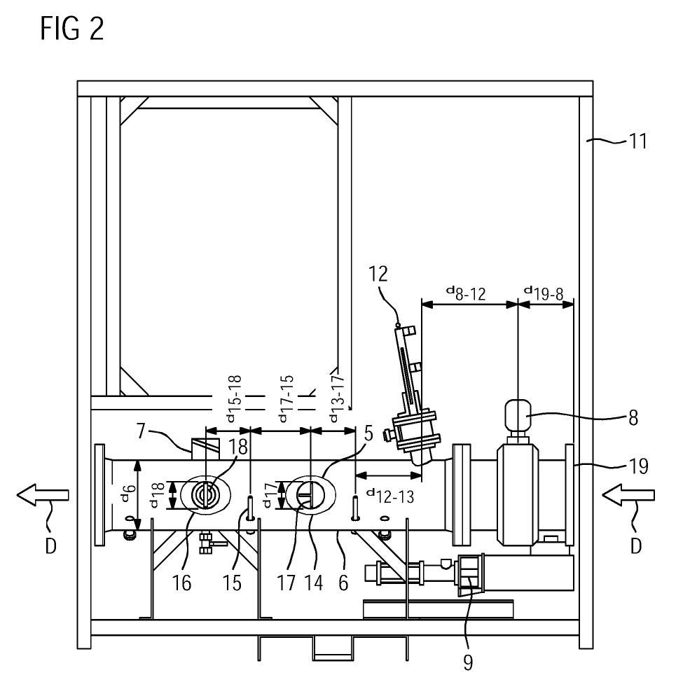

FIG. 2 shows a partial sectional representation of the apparatus;

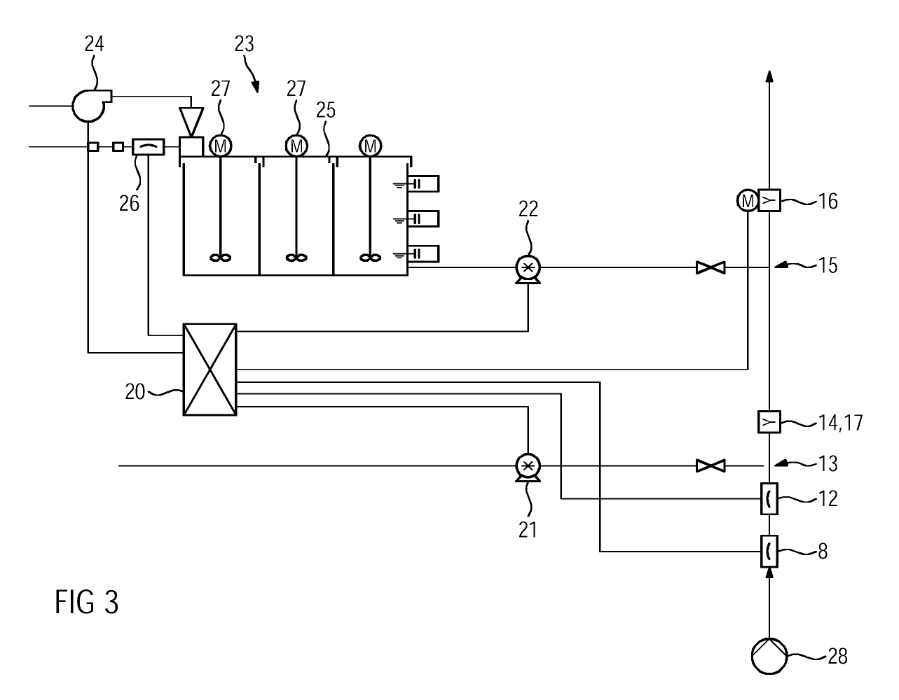

FIG. 3 show a construction diagram of one embodiment of the apparatus;

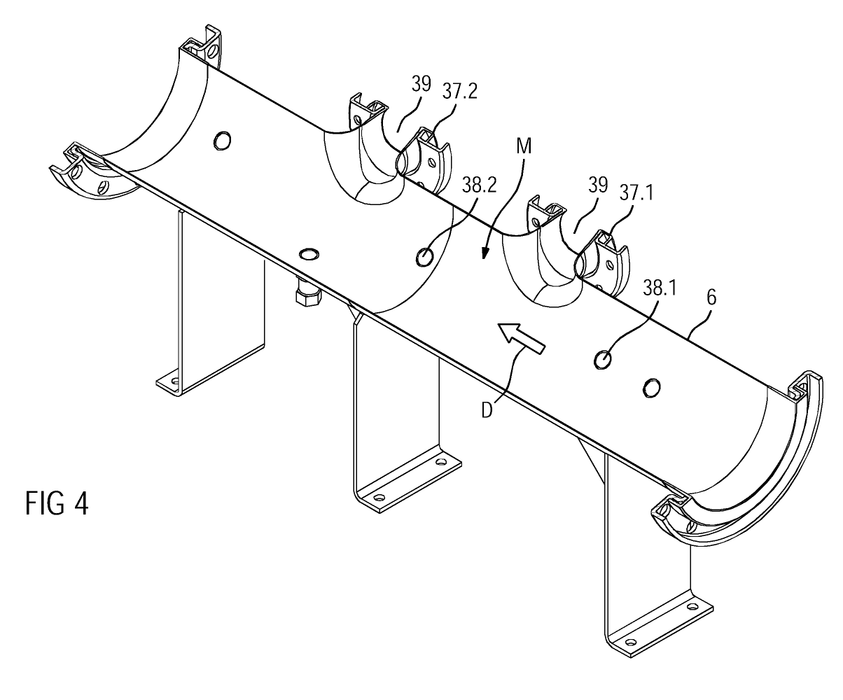

FIG. 4 shows a sectional representation of the apparatus in the region of the mixing sector;

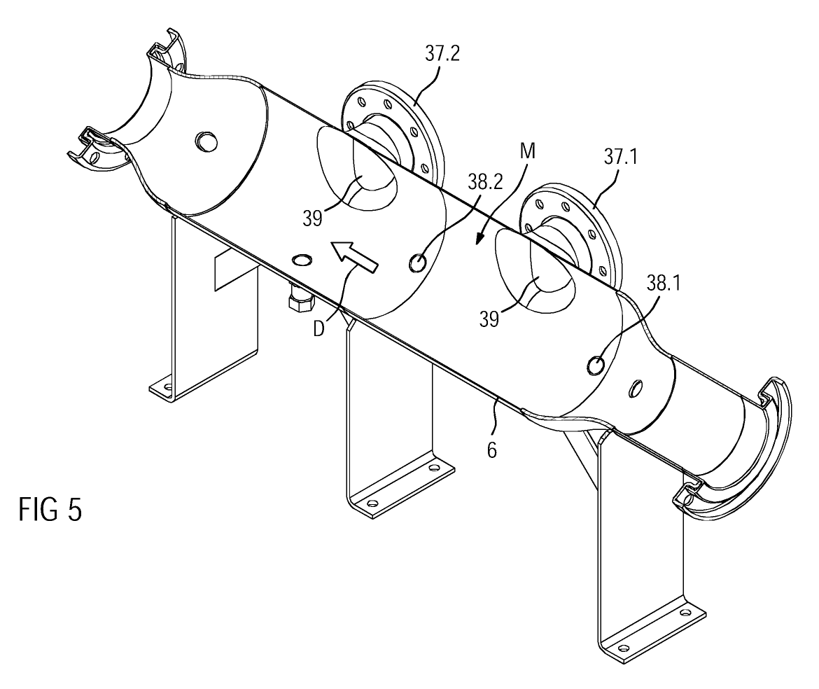

FIG. 5 shows a sectional representation of an alternative mixing sector;

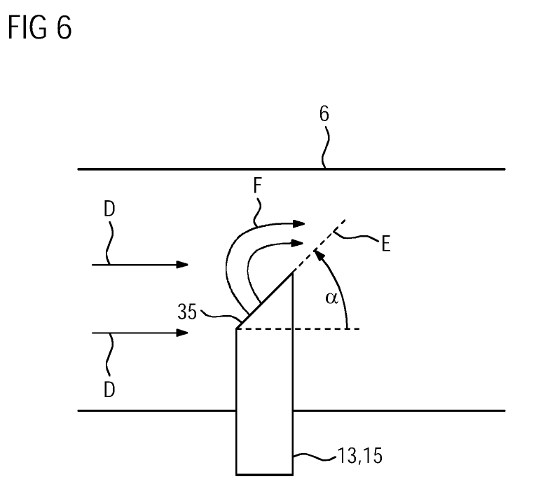

FIG. 6 shows a detail relating to feed lances of the apparatus;

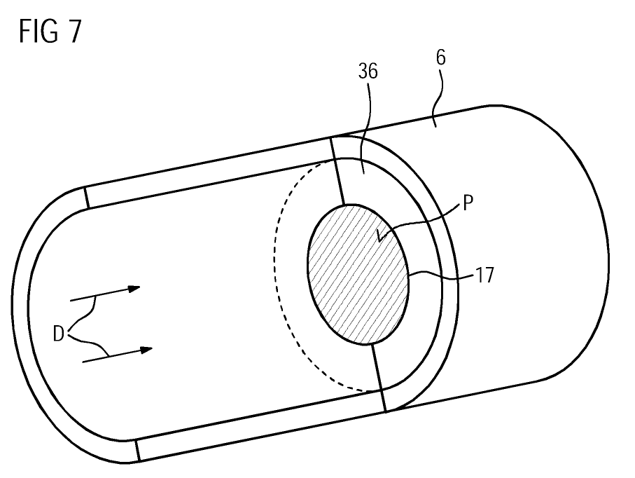

FIG. 7 shows a schematic representation relating to a detail of a further mixing unit of the apparatus; and

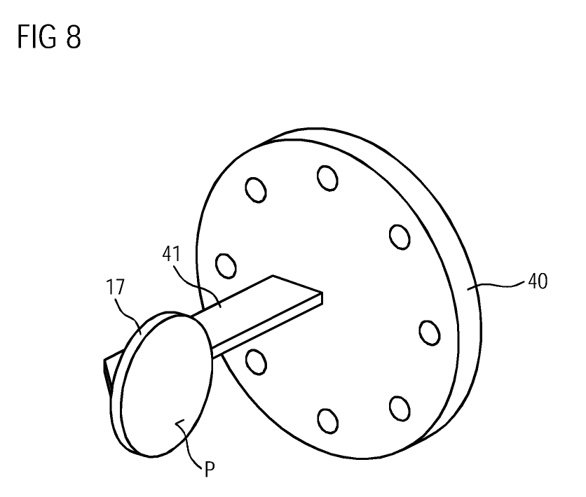

FIG. 8 shows an exemplary embodiment of a mixing unit according to FIG. 8, comprising an impact plate.

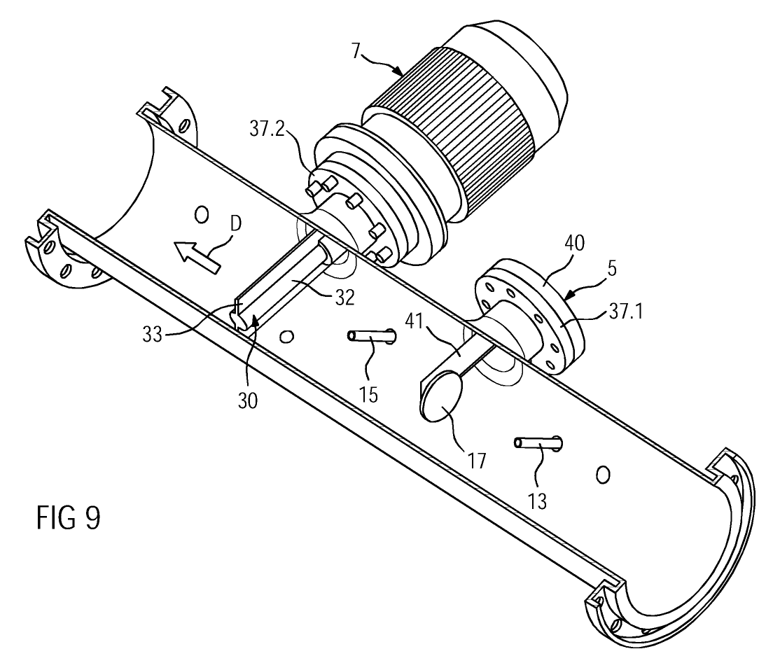

FIG. 9 shows a sectional representation of a pipeline with installed mixing units;

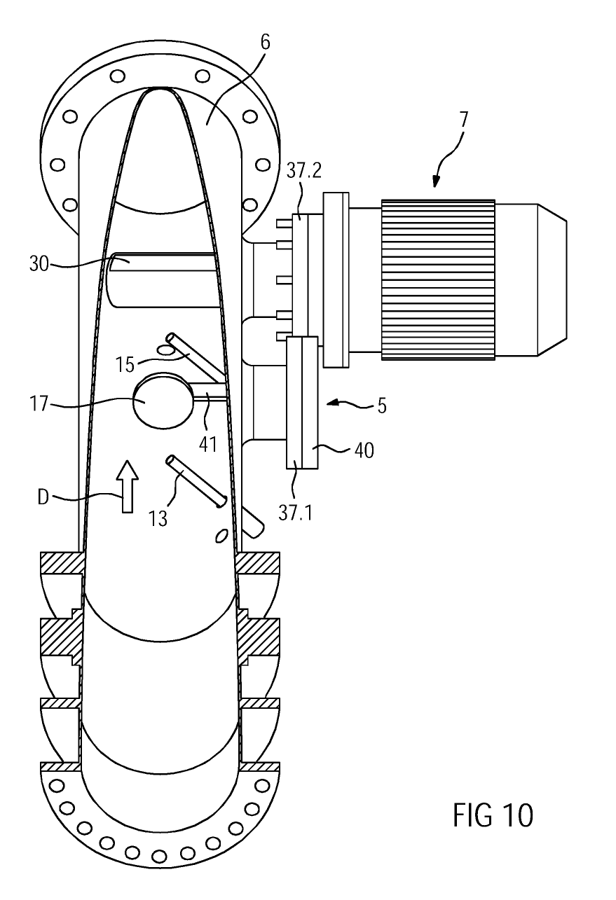

FIG. 10 shows a further sectional representation of the pipeline with installed mixing units.

Parts and components corresponding to one another in FIG. to FIG. 10 are designated with the same reference symbols.

FIG. 1 shows an exemplary apparatus for flocculating solids fractions of a solid-liquid mixture, and is referred to below for simplification as flocculation apparatus 2. The flocculation apparatus 2 may be mounted or installed, for example, in or on a mobile transport unit, such as a carrying frame or installation frame 11 (see FIG. 2), for example, comprising, for example forklift truck sockets and the like, or a container. By this means, in particular, flocculation apparatus 2 can be transported mobily and flexibly to the respective location of deployment.

In addition to the flocculation apparatus 2, furthermore, there may be one or more electrical switch cabinets 3, and, additionally, one or more (schematically shown) tanks, preparation units or mixing units 4 for one or more flocculating agents.

The flocculation apparatus 2 comprises a first mixing unit 5, which is installed on a pipeline 6, this pipeline forming or comprising in particular a mixing sector, and is designed for admixing a first flocculating agent. The first mixing unit 5 may, for example, be adapted and designed for admixing a calcium carbonate (CaCO₃)-based flocculating agent to a solid-liquid mixture, sludge for example, that is flowing through the mixing sector.

The flocculation apparatus 2 further comprises a second mixing unit 7 which is likewise installed on the mixing sector 6, and is designed for admixing a second flocculating agent. The second mixing unit 7 may be designed, for example, to admix the solid-liquid mixture, flowing through the mixing sector, with a flocculating agent based on a polymer, preferably an acrylamide-free polymer.

By admixing the first and second flocculating agents it is possible to achieve a coagulation of solids fractions of the solid-liquid mixture, and coagulated solids fractions can subsequently be removed by means, for example, of filtration, centrifugation, or sedimentation.

The flocculation apparatus 2 of FIG. 1 further comprises an optional flow rate meter 8, which, as in the present case, may be installed at the entry of the mixing sector, and which may be designed to ascertain or measure the quantity—for example, the volume flow or mass flow—of the solid-liquid mixture flowing through the mixing sector.

In the case of the flocculation apparatus 2 shown in FIG. 1, the (optional) flow rate meter 8 is located on the input side of the mixing sector. An output side or outlet opening of the mixing sector is given the reference symbol O. On the input and output sides, the flocculation apparatus 2 may comprise connection interfaces (not shown explicitly) as for example connection flanges, for connecting a conveying line for supplying and/or removing the solid-liquid mixture to and from the mixing sector, respectively.

In the case of the flocculation apparatus 2 shown in FIG. 1, accordingly, there is a flow traversal direction D indicated by the double arrow. Taking account of the flow traversal direction D, it is found for the working example of FIG. 1 that the first and second mixing units 5, 6 are connected fluidically downstream of the flow rate meter 8. Furthermore, the second mixing unit 7 is connected fluidically downstream of the first mixing unit 5, which is intended to mean that, viewed fluidically, the solid-liquid mixture flowing, or pumped, through the mixing sector passes first through the first mixing unit 5 and then through the second mixing unit 7.

A first pump unit 9 may be assigned, as shown in FIG. 1, to the first mixing unit 5, with the first pump unit 9 being designed to pump or convey the first flocculating agent via a first supply facility as for example a first supply lance 13, into the mixing sector, i.e., into the volume defined by the mixing sector. A line connection between first pump unit 9 and first supply lance 13 is represented by dashed lines in FIG. 1.

Correspondingly, a second pump unit 10 may be assigned to the second mixing unit 7, with the second pump unit being designed to pump or convey the second flocculating agent via a second supply facility, as for example a second supply lance 15, into the mixing sector, i.e., into the volume defined by the mixing sector. A line connection between second pump unit 10 and second supply lance 15 is represented with dashed lines in FIG. 1.

The flocculating agents may be supplied from the tank or from the preparation or mixing unit 4 to the first and/or second pump units via corresponding supply lines, as indicated in FIG. 1 by dashed lines.

Further details of embodiments of the flocculation apparatus 2 are also described below with reference to FIG. 2, which shows a schematic partial sectional representation of the flocculation apparatus 2.

The flocculation apparatus 2 may, as shown in FIG. 2, comprise an (optional) installation frame 12, on which components of the flocculation apparatus 2 may be installed, and with which the flocculation apparatus can be mounted in or on a mobile (transport) unit.

In the representation of FIG. 2 it can be seen that the flow rate meter 8 may be connected via a flange connection to the pipeline 6 defining the mixing sector. Connected fluidically downstream of the flow rate meter 8 may be an (optional) dry matter measurement unit 12, which is adapted and designed to ascertain or to measure the amount of dry matter in the solid-liquid mixture flowing through the mixing sector or in the solid-liquid mixture entering the mixing sector.

By combination in particular of the measurement values obtained from flow rate meter 8 and dry matter measurement unit 12, relating to quantity and dry content of the solid-liquid mixture supplied, it is possible for the flocculation apparatus 2 to ascertain automatically the quantity of first and second flocculating agents suitable or required in each case for the coagulation of the solids fractions in the solid-liquid mixture.

The flocculation apparatus 2 may comprise a control unit (see 20 in FIG. 3) which is adapted, and which may be coupled with the first and second mixing units 5, 7 in terms of control technology, in such a way that the respectively required amount of first and second flocculating agents is supplied to the mixing sector. For example, the control unit may be adapted to establish the conveying output of the first and/or second pump units 9, 10 in line with the particular amount of flocculating agents required.

Connected fluidically in series, in other words one after another, along the mixing sector, i.e., along the pipeline 6, is a first supply lance 13, which protrudes into the volume of the mixing sector defined by the pipeline 6, and a static mixer 14, these components being encompassed by the first mixing unit 5, and also a second supply lance 15, which protrudes into the volume of the mixing sector, and a dynamic mixer 16, these components being encompassed by the second mixing unit 7.

The supply lances 13, 15 project into the pipeline 6 or into the mixing volume transversely to the flow traversal direction D of the solid-liquid mixture, and supply openings of the supply lances 13, 15 are each disposed at that end of the supply lances 13, 15 that is sited approximately centrally within the pipeline 6. Accordingly, the first and second flocculating agents can be supplied approximately or in the region of the center axis of the flow which forms in the mixing sector, thereby enabling the achievement of comparatively homogeneous admixing and, in complement thereto, a comparatively good coagulation effect.

The static mixer 14 of the first mixing unit 5 may for example, as shown in FIG. 2, comprise an (optionally two or more) impact plate(s) 17, disposed in the flow volume of the pipeline, this plate or these plates being connected fluidically downstream of the first supply lance 13, more precisely downstream of the outlet opening of the first supply lance 13. By means of the impact plate 17 it is possible for the solid-liquid mixture admixed with the first flocculating agent to be commixed, by virtue of the local change of flow conditions brought about by the impact plate 17, for example. The impact plate 17 may, for example, be adapted such that it breaks up the flow locally and gives rise for example to turbulences, fluidizations, and so on. The use of an impact plate 17, and an accompanying comparatively effective commixing, have proven advantageous especially in the case of supply of a CaCO₃-based flocculating agent to sludges.

The impact plate 17 may, as shown in FIG. 2, be disposed perpendicularly to the center axis of the mixing volume or of the pipeline 6, more particularly such that its surface normal is aligned parallel to the flow traversal direction D.

With respect to the cross section of the mixing volume, or of the pipeline, the impact plate 17 may be disposed approximately centrally, and an annular gap may be formed between the inside wall of the pipeline 6 and the outer margin of the impact plate 17 in the case, for example, that pipeline 6 and impact plate 17 have a round cross section.

The dynamic mixer 16 of the second mixing unit 5 may for example, as shown in FIG. 2, comprise an (optionally two or more) mixing rotor(s) 18, which are motor-driven and protrude transversely to the flow traversal direction into the volume of the mixing sector, any such rotor being connected fluidically downstream of the second supply lance 15, more precisely downstream of the outlet opening of the second supply lance 15.

The mixing rotor may comprise mixing vanes, which are formed on a drive shaft driven by an electrical drive motor, which extend radially from the drive shaft, and which enable commixing of the solid-liquid mixture, already admixed with the first flocculating agent, with in particular the second flocculating agent. The dynamic mixer 16, or the mixing rotor 18, is more particularly designed to mix the solid-liquid mixture admixed with flocculating agents, so that coagulation of the solids fraction of the solid-liquid mixture is possible or takes place on the basis of the two flocculating agents.

The impact plate 17 of the static mixer 14 may, as already indicated, be designed, for example, in the manner of a circular disk, in which case, for a diameter, or nominal diameter, d₆ of the mixing sector or of the pipeline 6, respectively, of approximately 250 mm, the outer diameter d₁₇ of the impact plate 17 may be about 100 mm. Rotor blades of the mixing rotor 18 may be designed, for example, such that the outer diameter d₁₈ of the rotor 18 is likewise about 100 mm.

With regard to FIG. 2, a number of other specific dimensions of the flocculation apparatus 2, and mutual spacings of certain components, may be stated. Thus, for example, a distance d₁₉₋₈ measured in flow traversal direction D between pipeline inlet 19 and flow rate meter 8 may be in the region of 225 mm, and the distance d₈₋₁₂, i.e., center-to-center distance, between flow rate meter 8 and the downstream-sited measurement point of the dry matter unit 12 may be about 393 mm.

The first supply lance 13, more specifically its outlet opening, may be disposed at a distance d₁₂₋₁₃ of 263 mm, for example, downstream of the measurement point of the dry matter measurement unit 12. The impact plate 17 may be disposed at a distance d₁₃₋₁₇ of about 186 mm from the first supply lance 13, and the second supply lance 15, more precisely its outlet opening, may be disposed at a distance d₁₇₋₁₅ of about 245 mm from the impact plate 17.

A distance d₁₅₋₁₈ between the second supply lance 15, more precisely its outlet opening, and the mixing rotor 18, more precisely the center axis of the mixing rotor 18, may be about 186 mm.

For distances between supply opening(s) and mixer(s), reference is made additionally to the observations earlier on above, in which context it shall be mentioned that it is also possible for larger distances to be used between the mixing units, as for example up to 200 times the diameter of the mixing sector, or up to 50 m.

The stated dimensions and sizings of the components of the flocculation apparatus 2 in particular have proven especially advantageous with regard to coagulation of solids fractions in sludges, especially industrial sludges, as for example waste sludges from copper mines.

The operation of the apparatus is in particular elucidated further in reference to FIG. 3, which shows a construction diagram of the flocculation apparatus 2.

As can be seen from FIG. 3, the flocculation apparatus 2 comprises a control unit 20, which is connected in terms of control technology to a first metering pump unit 21 for the first flocculating agent, to a second metering pump unit 22 for the second flocculating agent, and to the dynamic mixer 16. Furthermore, the control unit 20 is connected by control technology to the flow rate meter 8 and to the dry matter measurement unit 12, so that the control unit 20 possesses at least measurement values relating to quantity and dry matter fraction of the solid-liquid mixture conveyed into the pipeline via a feed pump.

The control unit 20 may, as shown in FIG. 3, be additionally connected by control technology to an (optionally present) facility 23 for producing an acrylamide-free polymer solution. Where such a facility 23 is present, it may also possess an independent control unit, and need not necessarily be coupled by control technology to the control unit 20 of the flocculation apparatus 2.

The facility 23 for producing the polymer solution may comprise a charging unit 24 for charging a mixing or preparation tank 5 with polymer material, more particularly with pulverulent polymer material, and may comprise a liquid supply facility 26 for supplying a carrier liquid, water for example, for the polymer material. The mixing or preparation tank 25 may comprise one or more mixing chambers each with assigned, motor-driven mixers 27.

In the operation of the flocculation apparatus 2, the facility 23 for producing the polymer solution may first be operated in such a way that there is sufficient polymer solution of an acrylamide-free polymer available as second flocculating agent.

For the conditioning—dewatering, for example—of sludge, comprising the coagulation of solids fractions in the sludge, or generally of a solid-liquid mixture, the pipeline 6, comprising the mixing sector, has the solid-liquid mixture conveyed to it and conveyed through the mixing sector, via a conveying pump 28, which is fluidically connected to the pipeline inlet 19 of the pipeline 6.

By means of the flow rate meter 8 and of the dry matter unit 12, quantity and dry matter of the mixture supplied are ascertained, and the values thus ascertained are supplied to the control facility 20, which ascertains required or optimum amounts of first and second flocculating agents, respectively.

In the present example, the flocculation apparatus 2 may be designed to supply a CaCO₃-based first flocculating agent via the first metering pump unit 21 to the mixing sector via the first supply lance 13, this flocculating agent being combined with the solid-liquid mixture by means of the impact plate 17 of the static mixer.

Via the second metering pump unit 22, which is controlled correspondingly by the control unit 20 with regard to the amount of second flocculating agent metered in, an acrylamide-free polymer solution is supplied as second flocculating agent, by the second supply lance 15, to the solid-liquid mixture already combined with the first flocculating agent. The second flocculating agent is combined with the solid-liquid mixture by means of the dynamic mixer 16.

Following passage through the dynamic mixer, the solid-liquid mixture with admixed flocculating agents reaches the outlet opening O of the mixing sector, or of the pipeline, and can be supplied, for example, to a filter unit (not shown) connected fluidically downstream, for the purpose of removal of coagulated solids fractions.

FIG. 4 shows a sectional representation of the apparatus 2 in the region of the mixing sector M, defined by the pipeline 6, or in a corresponding mixing volume. Merely for the sake of completeness it may be stated that the pipeline is installed and supported on support feet which can be screwed to a base.

The pipeline 6 may, as shown in FIG. 4, two connection couplings 37, connected fluidically in series in the flow traversal direction and sited, for example, on the same side of the pipeline 6, these connection couplings comprising, for example, a flange connection in each case, for the purpose of connecting the first 5 and second 6 mixing units, particularly in a fluid-tight manner. The connection couplings 37 may be used for example in a disposition sited to the side in operation of the apparatus 1.

Sited upstream of the connection couplings 37 in terms of the flow traversal direction D it is possible, as shown in FIG. 4, for insertion openings 38.1 and 38.2, or engagement openings, for the first 13 and second 15 supply lances, respectively, to be provided in the walls of the pipeline. The insertion openings 38, or more precisely their center points, may lie, for example, on a line which runs in the longitudinal direction of the pipeline 6; in other words, the insertion openings 38 may be disposed flush one after another as viewed in the flow traversal direction. As can be seen in FIG. 4, the pipeline may be disposed, in operation of the apparatus, in such a way that the engagement openings 38 are disposed below the level of the passage openings 39 present in the region of the connection couplings 37, more particularly on the same side as the connection couplings 37, in the pipeline 6.

FIG. 5 shows a sectional representation of an alternative mixing sector M, or an alternative pipeline geometry of the pipeline 6. The pipeline 6 of the exemplary embodiment in FIG. 5 is tapered toward both ends of the mixing sector M, or at both ends of the pipeline 6.

Expressed in other words, the pipeline 6 is widened radially in relation to the longitudinal axis, with the widening as viewed in the longitudinal direction of the pipeline 6, or parallel to the flow traversal direction D, being selected such that at least the passage openings 39 and the insertion openings 38 are included. By means of widening it is possible in certain circumstances to achieve improved commixing, and/or the mixing sector M can be modified for the particular solid-liquid mixture to be treated, this modification being in relation to geometry, disposition and position of the first mixing unit 5 and second mixing unit 7.

The second mixing unit 7 may comprise a rotor unit 30, connected to the pipeline 6 via a flange connection 29, this unit having a drive shaft 31 and having a mixing rotor unit 32 mounted at the distal end of the drive shaft 31. The rotor body of the mixing rotor unit 32 has a cylindrical design in the present example, and on opposite longitudinal sides has a respective mixing vane 33, as can be seen from FIG. 9, for example. The mixing rotor unit 32, more particularly the mixing vanes 33, in operation of the flocculation apparatus 2, produce mixing of the second flocculating agent F2 with a solid-liquid mixture flowing past at the second mixing unit 7.

As can be seen, for example, from FIG. 1 and FIG. 9, the second flocculating agent F2 may be supplied via a nozzle or lance 15 and the like that is connected fluidically upstream, for example, of the mixing rotor unit 32, being therefore disposed upstream.

One example of a corresponding nozzle or lance arrangement is shown in FIG. 6. Specifically, FIG. 6 shows a cross section of the pipeline 6 in the region, for example, of the first or second supply lance 13 or 15. In the example of FIG. 6, the supply lance 13 or 15 has a lance outlet opening 35 positioned obliquely to the flow or flow direction or flow traversal direction D, and the respective flocculating agent F, whether it is the first flocculating agent or the second flocculating agent F2, can be supplied via said opening 35.

In the present example, specifically, the lance outlet opening 35 is adapted and aligned in such a way that an angle α of approximately 45 degrees is formed between the flow traversal direction D and the opening plane E of the lance outlet opening 35, measured counterclockwise in the direction of rotation. The angle selected may also be different, according to the properties of the flocculating agent F and/or of the solid-liquid mixture to be treated. Furthermore, the lance outlet opening 35 may have a different attitudinal position to the flow, and/or the opening plane E of the lance outlet opening 35 may have a different orientation relative to the flow traversal direction D or to the pipeline 6.

FIG. 7 shows a further detail of the flocculation apparatus or of a flocculation apparatus 2 of the invention, in the region of the static mixer 14. Specifically, the static mixer 14 of FIG. 7 is designed in the form of an impact unit, comprising an impact plate 17 fastened in the pipeline 6.

In the example of FIG. 7, the impact plate 17 has a round design, meaning that the impact plate 17 has a round impact surface P. The geometry of the impact surface P and of the impact plate 17 are selected in the present example such that, between the inside walls of the pipeline 6 and the outer margin of the impact surface P or impact plate 17, an annular gap 36 is formed, having a gap width which is approximately constant as viewed in the radial direction with respect to the pipeline 6. It may be noted that the orientation, position and/or geometry and/or shape of the impact plate may also be differently designed, depending, for example, on the properties of the particular solid-liquid mixture to be treated, more particularly sludge.

In the case of a pipeline diameter of 25 cm, for example, the diameter of the impact plate 17 may be 10 cm, for example, thus forming an annular gap having a width of about 75 mm between the inside walls of the pipeline 6 and the outer margin of the impact plate 17. Such geometries are suitable in particular for the mixing of flocculating agents with sludges—with regard to the sludges, reference is made in particular to the examples referred to earlier on above.

The effect of the impact plate 17 disposed in the volume of the pipeline 6, or of the impact unit, is that there is an increase in the flow rate in the region of the impact unit or impact plate 17 in the pipeline 6, and so in the region of the impact plate 17, more particularly downstream of the impact plate 17, given a suitable flow rate, it is possible for flow turbulences and associated fluidizations to develop, which effect, evoke and/or promote the mixing of the first flocculating agent with the solid-liquid mixture.

FIG. 8 shows a specific working example of the static mixer 14. As shown in FIG. 8, the static mixer 14 may have a flange plate 40, which can be joined to the corresponding connection coupling 37, more particularly to the corresponding connection flange, and in this flange plate 40 there may be, for example, drilled holes around the marginal side for the purpose of screw fastening of the flange plate 40 to the connection coupling 37.1.

On the flange plate 40, as for example in a central region or a region adjacent to the center, there may be a fastening arm 41 which projects from the flange plate 40 and is fastened to the flange plate 40. At an end remote from the flange plate 40, the fastening arm 41 may be connected to a or the impact plate 17, or the impact plate 17 may be mounted there. The length of the fastening arm 41 is selected such that in the installed state of the flange plate 40 on the connection coupling 37.1, the impact plate is positioned approximately centrally in the pipeline 6. The drilled holes made in the flange plate 40 may be adapted such as to enable a form of fastening wherein the impact plate 17, i.e. the impact surface P, is disposed substantially perpendicularly to the flow traversal direction D, or such that a corresponding angle of inclination exists between impact surface P and flow traversal direction D.

FIG. 9 shows a sectional representation of the pipeline 6 with installed mixing units 5, 7, where the first mixing unit 5, comprising the static mixer 14, is installed on the respective connection coupling 37.1, so that the impact plate 17 is disposed in a perpendicular orientation to the flow traversal direction D in the mixing sector M and is disposed fluidically downstream of the first supply lance 13. FIG. 10 shows a further sectional representation of the pipeline 6 with installed mixing units 5, 7 as viewed in the direction of the flow traversal direction D.

The second mixing unit 7, comprising a dynamic mixer 16 with rotor unit 30 comprising drive motor, is installed via a flange connection on the other connection coupling 37.2. In the present example, the rotor unit 30 is disposed fluidically downstream of the second supply lance 15, meaning that the respective second flocculating agent is supplied via the second supply lance 15 to the mixing rotor unit 32.

The extent to which the supply lances 13, 15 are introduced into the pipeline 6 may for example be such that in operation of the apparatus 1, the respective flocculating agents can be introduced approximately centrally, with respect to the pipe cross section or the cross section of the mixing sector M, into the solid-liquid mixture flowing through the mixing sector M. As a result of the development of flow eddies due to the impact plate 17, it is possible, in the fluidically downstream volume, to achieve commixing of the solid-liquid mixture with the first flocculating agent. With a suitable fluidic distance between impact plate 17 and second supply lance 15, furthermore, it is also possible, for example, at least to promote the introduction of the second flocculating agent, there being active commixing of the solid-liquid mixture with the two added flocculating agents by means in particular of the downstream active mixer 7.

The described operation of the flocculation apparatus with two-stage admixing of a first and a second flocculating agent, and with the use of different types of mixer for the first flocculating agent, based for example on CaCO₃, and for the second flocculating agent, based for example on an acrylamide-free polymer, is suitable particularly for the conditioning of sludges, as for example spoil sludges from copper mines.

Through the possibility of the metering of the flocculating agents by the first and second mixing units and through the two-stage, successive supply of the flocculating agents, in particular, it is possible to achieve a comparatively good coagulation outcome with comparatively good solid-liquid separation.

1. An apparatus (2) for flocculating solids fractions of a solid-liquid mixture, more particularly sludge or graywater, comprising a mixing sector (6, M) designed for conducting the solid-liquid mixture and comprising a first mixing unit (5), having a static mixer (14, 17, P) adapted for admixing a first flocculating agent (F), and a second mixing unit (7), connected in series fluidically with the first mixing unit (5) and optionally sited fluidically downstream, having a dynamic mixer (16, 18) adapted for admixing a second flocculating agent (F2) to the mixing sector (6, M).

2. The apparatus (2) as claimed in claim 1, wherein the static mixer (14) comprises one or more impact means (17), designed in the volume of the mixing sector (6, M), and/or the dynamic mixer (16) comprises one or more mixing rotors (18, 32, 33) protruding into the volume of the mixing sector (6, M) and coupled to a motor drive unit.

3. The apparatus (2) as claimed in claim 2, wherein the one or more impact means (17) is at least one of the at least one impact plate (17), wherein the at least one impact plate has an impact surface (P) which is disposed transversely, to the flow traversal direction (D) resulting for the solid-liquid mixture in regular operation, and/or wherein at least one of the at least one impact plate (17), is disposed centrally in relation to a cross-sectional area of the mixing sector (6, M) that exists at the assembly location of the impact plate (17), and/or wherein the free cross-sectional area of the mixing sector (6, M) at the assembly location of the impact plate (17), is 5 to 7 times, more the impact plate area (P), measured transversely to the flow traversal direction (D).

4. The apparatus as claimed in any of claim 1, wherein the first mixing unit (5) comprises a first supply unit (13), designed for supplying the first flocculating agent (F) to the mixing sector (6, M), having at least one first supply opening (35), sited fluidically upstream of the static mixer (14), for the first flocculating agent (F) to the mixing sector (6, M), and/or wherein the second mixing unit (7) comprises a second supply unit (15), designed for supplying the second flocculating agent (F2) to the mixing sector (6, M), having at least one second supply opening (35), sited fluidically upstream of the dynamic mixer (16), for the second flocculating agent (F2) to the mixing sector (6, M), wherein the first supply unit (13) optionally comprises a first supply lance (13), protruding into the mixing volume defined by the mixing sector (6, M

5. An apparatus (2) for admixing flocculating agents (F) into a solid-liquid mixture comprising a mixing sector (6, M) designed for conducting the solid-liquid mixture and comprising a first (5) and a second (7) mixing unit, wherein the second mixing unit (7) is sited fluidically downstream of the first mixing unit (5), and the first mixing unit (5) is adapted for admixing a first flocculating agent (F) to the mixing sector (6, M), and the second mixing unit (7) is adapted for admixing a second flocculating agent (F2) to the mixing sector (6, M), wherein the first flocculating agent (F) comprises a carbonate and/or calcium salt, and the second flocculating agent (F2) comprises at least one acrylamide-free polymer.

6. The apparatus (2) as claimed in claim 5, wherein a distance, measured in flow traversal direction (D), between first supply opening (35) and mixer (14, 17, P) of the first mixing unit (5) and/or between second supply opening (34, 35) and mixer (18, 32) of the second mixing unit (7) is 0.6 to 1.2 times, the free cross section of the mixing sector (6, M) at the location of the first (5) or second (7) mixing unit, respectively, and/or wherein a distance, measured in flow traversal direction (D), between the mixer (14, 17, P) of the first mixing unit (5) and second supply opening (34, 35) is between 0.8 and 1.2 times the free diameter (d₆) of the mixing sector (6, M) at the location of the first mixing unit (5) and/or at the location of the second supply opening (34, 35).

7. The apparatus as claimed in claim 5, wherein the polymer is an anionic or cationic polymer and/or wherein the polymer comprises a polyelectrolyte.

8. A process for flocculating solids fractions of a solid-liquid mixture, more particularly sludge or graywater comprising the steps of conducting the solid-liquid mixture through a mixing sector (6, M), and admixing a first flocculating agent (F) to the solid-liquid mixture in the mixing sector (6, M) by means of a static mixer (14, 17, P) of 2 first mixing unit (5), and admixing a second flocculating agent (F2) to the solid-liquid mixture in the mixing sector (6, M) by means of a dynamic mixer (16, 18, 32, 33) of a second mixing unit (7), optionally sited downstream, and connected fluidically in series to the first mixing unit (5).

9. A process for flocculating solids fractions of a solid-liquid mixture, more particularly sludge or graywater, as claimed in claim 8, wherein the solid-liquid mixture is conveyed through the mixing sector (6, M), and wherein the solid-liquid mixture in the mixing sector (6, M) is admixed first with a or the first flocculating agent, comprising a carbonate and/or calcium salt, and then, fluidically downstream, with a or the second flocculating agent comprising at least one acrylamide-free polymer.

10. The process as claimed in claim 8, wherein the first flocculating agent (F) is supplied to the solid-liquid mixture via a first supply unit (13) sited upstream of the static mixer (14, 17, P) or, of a mixer (14, 17, P) of the first mixing unit (5), and/or wherein the second flocculating agent (F2) is supplied to the solid-liquid mixture via a second supply unit (15), sited fluidically upstream of the dynamic mixer (16, 18, 32, 33) or, of a mixer (16, 18, 32, 33) of the second mixing unit (7), and/or wherein the first flocculating agent (F) is supplied to the solid-liquid mixture via a first supply lance (13) protruding into the mixing volume defined by the mixing sector (6, M), and/or wherein the second flocculating agent (F2) is supplied to the solid-liquid mixture via a second supply lance (15), which protrudes into the mixing volume defined by the mixing sector (6, M), and/or wherein the first and/or second flocculating agents (F, F2) are/is supplied at a position sited approximately centrally in the free cross section of the mixing sector (6, M), and/or wherein the first and/or second flocculating agents (F, F2) is or are supplied to the solid-liquid mixture with a directional component running transversely, to the flow traversal direction (D) of the solid-liquid mixture that prevails at the respective location of supply in the mixing sector (6, M), and/or wherein a flow-technical distance in flow traversal direction (D) of the solid-liquid mixture between location (13, 15) of the addition of the first and/or second flocculating agents (F, F2) and the mixer of the respective first or second mixing unit (5, 7) is 0.6 to 1.2 times, more particularly 0.74 times, the free diameter (d6) of the mixing sector (6, M) measured at the location of the first or second mixing unit (5, 7), respectively, and/or wherein a flow-technical distance between location (15, 35) of the addition of the second flocculating agent (F) and first mixing unit (5), is between 0.8 and 1.2 times the free diameter (d6) of the mixing sector (6, M) at the location of the first mixing unit (5) and/or at the location (15, 35) of the addition.

11. The apparatus (2) as claimed in claim 2, wherein the one or more impact means (17) are impact plates (17).

12. The apparatus (2) as claimed in claim 3, wherein the impact surface is disposed perpendicularly.

13. The apparatus (2) as claimed in claim 3, wherein the free cross-sectional area of the mixing sector (6, M) at the assembly location of the impact plate (17) is 6.25 the impact plate area (P), measured transversely to the flow traversal direction (D).

14. The apparatus (2) as claimed in claim 4, wherein the first supply unit (13) comprises a first supply lance (13), protruding into the mixing volume defined by the mixing sector (6, M), there being designed on said lance at least one of the at least one first supply opening (35), and/or the second supply unit (15) comprises a second supply lance (15), protruding into the mixing volume defined by the mixing sector (6, M), there being designed on said lance at least one of the at least one second supply opening (35), wherein at least one first and/or at least one second supply opening (35) is or are designed at a distal end, sited within the mixing volume and positioned more particularly approximately centrally to the free cross section of the mixing sector (6, M), of the first and second supply lances (13, 15), respectively, and/or the first and/or second supply openings (34, 35) being designed transversely, to the flow cross section of the mixing sector (6, M) at the location of the respective supply opening, and/or wherein a distance, measured in flow traversal direction (D), between first supply opening (35) and static mixer (14, 17, P) and/or between second supply opening (34, 35) and dynamic mixer (16) is 0.6 to 1.2 times the free diameter (d6) of the mixing sector (6, M) at the location of the first (5) and second mixing units (7), respectively, and/or wherein a distance measured in the flow traversal direction (D) between the first mixing unit (5) and second supply opening (34, 35) is between 0.8 and 1.2 times the free diameter (d₆) of the mixing sector (6, M) at the location of the first mixing unit (5) and/or at the location of the second supply opening (34, 35).

15. The apparatus (2) as claimed in claim 5, wherein the first flocculating agent (F) comprises calcium carbonate (CaCO3) or superficially phosphoric acid (H3PO4)-treated calcium carbonate (CaCO3).
